(19) United States
(12) Patent Application Publication
(10) Pub. No.: US 2011/0072951 A1
(43) Pub. Date: Mar. 31, 2011

(54) Scoring Apparatus for Card and Cover Feeders

(75) Inventor: Glen Roger Caron, Deerfield, NH (US)

(73) Assignee: GOSS INTERNATIONAL AMERICAS, INC., Durham, NH (US)

(21) Appl. No.: 12/889,072

(22) Filed: Sep. 23, 2010

Related U.S. Application Data
(60) Provisional application No. 61/277,516, filed on Sep. 25, 2009.

(51) Int. Cl. B26D 3/08

(52) U.S. Cl. 83/886

(57) ABSTRACT

A scoring device for scoring a substrate is provided that includes a receiving drum including an outer surface and a receiving groove formed in the outer surface and a scoring drum that includes a scoring rib and a compressible contacting surface contacting the outer surface of the receiving drum.

This claims the benefit of U.S. Provisional Application No. 61/277,516 filed Sep. 25, 2009, and hereby incorporated by reference herein.

The present invention relates generally to post-press equipment in the graphics industry and more specifically to a scoring apparatus and method for card and cover feeders.

### BACKGROUND OF INVENTION

Goss International Americas, Inc., the assignee of the present invention, produces FF105 and FF155 Cover and Card Feeders that include a sharp steel scoring wheel on a drum riding against the back of an endless urethane v-belt wrapped around an aluminum drum. The adjacent drums grip a cover or card and pull the cover or card between the scoring wheel and the v-belt. The scoring wheel cuts into the cover or card, creating a score.

Mueller Martini, a company having a principal place of business in Hergiswil, Switzerland, uses a sharp steel scoring wheel that rides in a receiving groove on a steel drum.

Tech-ni-Fold Ltd., a company having a principal place of business in Leicestershire, England, sells a spine creaser kit that fits on cover feeders. The kit includes rubber strips that wrap around the rotor drum of the feeder and two steel scoring wheels. The rubber strips have a rib on one side, which helps create the score, and a locating v-rib on the other side that ensures the proper location of the strip. The scoring wheels have grooves in them that the rib on the strips fit into. The strips are described in WO 2004/078469.

### BRIEF SUMMARY OF THE INVENTION

A scoring device for scoring a substrate is provided that includes a receiving drum including an outer surface and a receiving groove formed in the outer surface and a scoring drum that includes a scoring rib and a compressible contacting surface contacting the outer surface of the receiving drum.

A scoring device for scoring a substrate is also provided that includes a receiving drum including a receiving wheel having a circumferential groove formed therein and at least one strip-shaped insert in the circumferential groove, the at least one strip-shaped insert including a receiving groove formed therein; and a scoring drum including a scoring rib entering the receiving groove.

### BRIEF DESCRIPTION OF THE DRAWINGS

The present invention is described below by reference to the following drawings, in which:

FIG. 1 shows schematically shows perspective view of a scoring device according to an embodiment of the present invention;

FIG. 2 schematically shows a side view of a nip of the scoring device shown in FIG. 1; and

FIG. 3 shows a more detailed view of a receiving drum of the scoring device shown in FIG. 1.

### DETAILED DESCRIPTION

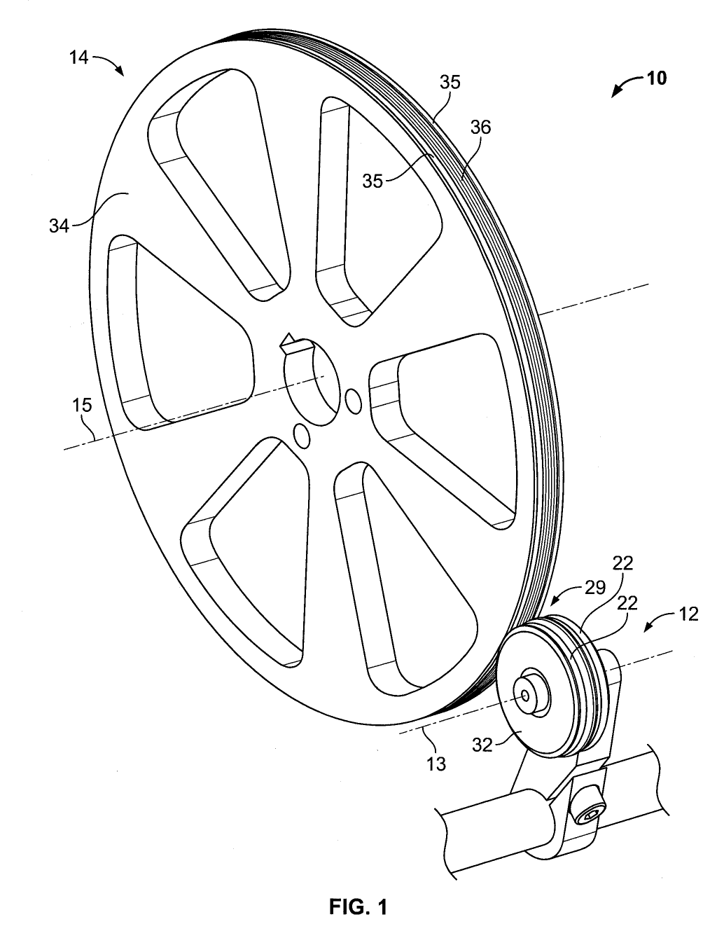

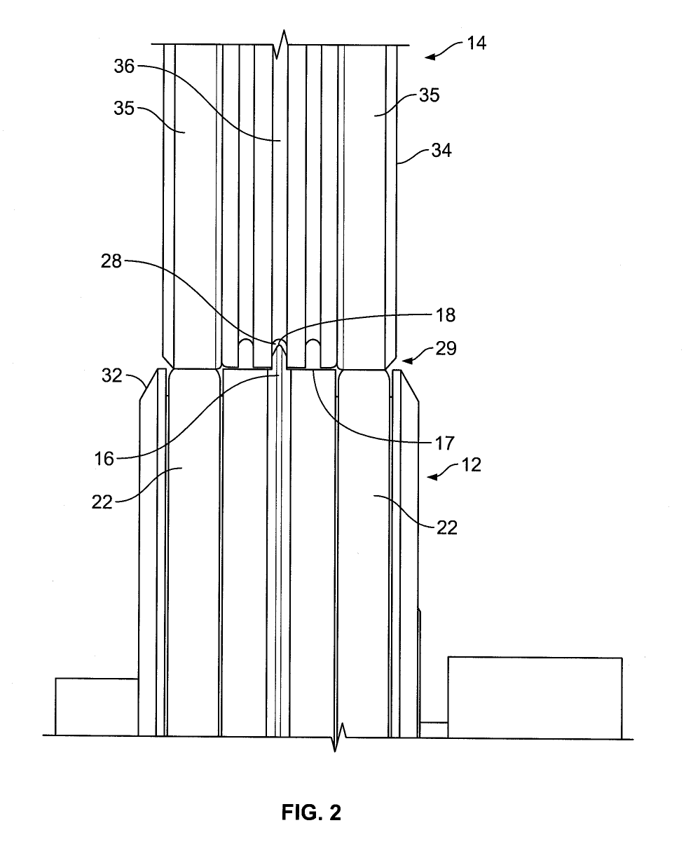

FIG. 1 schematically shows perspective view of a scoring device 10 according to an embodiment of the present invention. Scoring device 10 includes a scoring drum 12 that works in combination with a receiving drum 14 to score a substrate, which for example may be a card or a cover. During operation, receiving drum 14 is rotated about an axis 15 by a motor and receiving drum 14 contacts scoring drum 12 at a nip 29 such that receiving drum 14 drives scoring drum 12 about an axis 13. Scoring drum 12 includes a scoring wheel 32 that has a tapered rib 16 (FIG. 2) projecting from an outer surface 17 and extending circumferentially about scoring drum 12. In a preferred embodiment, scoring wheel 32 is made of steel. Tapered rib 16 has a smooth circular tip 18 for contacting the substrate.

A compressible contacting surface, which in a preferred embodiment is formed by o-rings 22 mounted on scoring wheel 32, projects just past outer surface 17 and contacts rim portions 35 of receiving wheel 34 so that receiving drum 14 may drive scoring drum 12. In a preferred embodiment, receiving wheel 34 is metal.

Receiving drum 14 includes a receiving material 36 between two rim portions 35 at an outer circumference of receiving drum. Receiving material 36 includes a receiving groove 28 (FIG. 2) formed therein. During scoring, rib 16 enters receiving groove 28 (FIG. 2) to score a substrate passing between drums 12, 14. A scoring pressure of scoring device 10 may adjusted by slightly varying the distance between axes 13, 15. Adjusting the scoring pressure may allow an operator to change the width and depth of the score. O-rings 22 are formed of a compressible material and allow the scoring pressure to be adjusted without risking the reliability of driving scoring drum 12 with receiving drum 14. To achieve a narrow score, o-rings 22 and receiving drum 14 are forced together with only a light pressure so that rib 16 only slightly enters receiving groove 28 (FIG. 2). To increase the scoring pressure, and achieve a wider score, the distance between axes 13, 15 may be decreased so that o-rings 22 are compressed by drum 14 and rib 16 enters deeper into receiving groove 28 (FIG. 2). The compressibility of o-rings 22 may advantageously allow scoring device to produce different sized scores without varying the size of rib 16. In a preferred embodiment, o-rings 22 are made of urethane.

In an alternative embodiment, receiving drum 14 may include a compressible contacting surface that contacts an incompressible or compressible portion of scoring drum 12.

FIG. 2 schematically shows a side view of scoring drum 12 and receiving drum 14 at nip 29. Tip 18 of tapered rib 16 extends into receiving groove 28 of receiving material 36 as o-rings 22 held in grooves in scoring wheel 32 are in contact with rim portions 35 of receiving wheel 34.

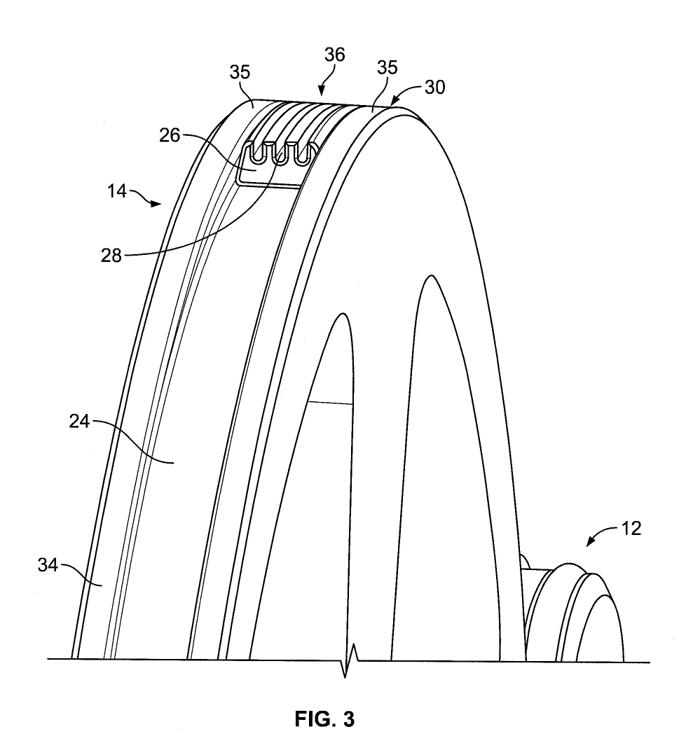

FIG. 3 shows a more detailed view of receiving drum 14. Receiving drum 14 includes a receiving wheel 34 that has a circumferential groove 24 formed therein. Receiving wheel 34 is contoured to receive an elastic receiving material 36. In a preferred embodiment, receiving material 36 may advantageously be formed of a plurality of replaceable inserts 26 made of a compressible material, such as urethane. A cross-section of groove 24 may be dovetail shaped and inserts 26 may be tapered to securely snap into groove 26 between rim portions 35. Because receiving material 36 is formed by inserts 26, which are shaped as strips, and not an endless belt, maintaining and replacing receiving material 36 may be quicker and easier. In a preferred embodiment, receiving groove 28 is formed in each of inserts 26. In an alternative embodiment, instead of using multiple inserts 26, a single insert, in the form of one long strip of material, such as urethane, may be inserted into groove 24.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A scoring device for scoring a substrate comprising:
a receiving drum including an outer surface and a receiving groove formed in the outer surface; and
a scoring drum including a scoring rib and a compressible contacting surface contacting the outer surface of the receiving drum.

2. The scoring device recited in claim 1 wherein the scoring drum includes a scoring wheel and the compressible contacting surface is mounted on the scoring wheel.

3. The scoring device recited in claim 2 wherein the compressible contacting surface includes at least one o-ring.

4. The scoring device recited in claim 1 wherein the receiving drum includes a receiving wheel having a circumferential groove formed therein and a receiving material located in the circumferential groove.

5. The scoring device recited in claim 4 wherein the receiving groove is formed in the receiving material.

6. The scoring device recited in claim 4 wherein the receiving material is formed by at least one strip-shaped insert.

7. The scoring device recited in claim 6 wherein the at least one strip-shaped insert is a plurality of strip-shaped inserts.

8. The scoring device recited in claim 4 wherein the circumferential groove has a dovetail-shaped cross-section.

9. A scoring device for scoring a substrate comprising:
a receiving drum including a receiving wheel having a circumferential groove formed therein and at least one strip-shaped insert in the circumferential groove, the at least one strip-shaped insert including a receiving groove formed therein; and
a scoring drum including a scoring rib entering the receiving groove.

10. The scoring device recited in claim 9 wherein the scoring drum includes a compressible contacting surface contacting an outer surface of the receiving drum.

11. The scoring device recited in claim 10 wherein the scoring drum includes a scoring wheel and the compressible contacting surface is mounted on the scoring wheel.

12. The scoring device recited in claim 11 wherein the compressing contacting surface is at least one o-ring.

13. The scoring device recited in claim 9 wherein the at least one strip-shaped insert is a plurality of strip-shaped inserts.
